(19) United States
(12) Patent Application Publication
(10) Pub. No.: US 2005/0247364 A1
(43) Pub. Date: Nov. 10, 2005

(54) Laying pipe

(76) Inventors: Andrea De Lucca, Remanzacco (IT); Alfredo Poloni, Fogliano Redipuglia (IT)

Correspondence Address: STETINA BRUNDA GARRED & BRUCKER, 75 ENTERPRISE, SUITE 250, ALISO VIEJO, CA, 92656, US

(21) Appl. No.: 10/520,034

(22) PCT Filed: Jun. 30, 2003
(86) PCT No.: PCT/EP03/06913

§ 371 Date: Dec. 30, 2004

(30) Foreign Application Priority Data
Jul. 1, 2002 (IT) MI2002A001444

(51) Int. Cl. F16L 9/14

(52) U.S. Cl. 138/142; 72/66

(57) ABSTRACT

A laying pipe (1) for a laying head for winding rounded rods comprises a first external pipe (5) with a first rectilinear section (2) and a second spiral section (3). A second internal pipe (10) in a singile piece, with external diameter equal to the internal diameter of the first pipe (5) is inserted inside it in the first section (2). The laying pipe also has a sleeve (6) fixed at the rod entry end (4) which has the entry edges with filter or a chamfer.

### FIELD OF THE INVENTION

The present invention relates to a laying pipe for hot rolled products into ring or spiral shapes and particularly to a spiral-forming pipe inserted on a rotating laying head or a rotor belonging to such a device.

### STATE OF THE ART

Hot rolling of metallic materials for the production of long rounded rods provides for a stage in which the product, in the form of a wire, rod, thin bar or similar, is wound into coils or rolls for its storage, transport or further manipulation. In order to carry out the winding operation of the metal wire into ring shapes, in the past, devices fitted with a rotating laying head comprising, amongst other elements, a pipe fixed solidly to the rotating laying head, and also rotating itself have been designed, into which the wires are made to run to make them follow the trajectory generally in the form of a spiral, characteristic of the winding of a wire onto a coil. The laying pipe is an element which is very stressed by the forces generated in the wire winding operation, given the high rotation speeds at which the laying heads are made to rotate. For example, in modern rolling mills, metallic wire finishing speeds in excess of 120 m/s are reached which lead to laying head rotational velocities of around 2000-3000 rpm.

The forces acting on the laying pipe during the operation are therefore of centrifugal and frictional type. Therefore in the past, efforts to reduce wear of the pipe and the metallic rod have been made to seek solutions to avoid scratching or damaging the rod which would compromise its structural and commercial quality.

In the known art, solutions which envisage particular forms of the laying pipes to optimise the characteristics of the coiling operation and to reduce wear of the internal surface of the pipe to a minimum have been proposed. By optimising the form of the pipe, one guarantees a constant and well distributed contact of the rod along the entire pipe and one obtains as a result greater stability in the formation of the spiral, at the same time reducing the specific contact pressures and therefore wear, above all in the rolling of small diameter products at high speed. These types of laying pipes have an internal diameter which varies from around 30 to 40 mm, and an external diameter of around 50 mm to offer the structural resistance due to the stresses generated during the laying operation. With pipes of such dimensions it is possible to carry out coiling operations of rods and rolling products in general, with diameters reaching around 25 mm.

However, laying pipes of these dimensions have not shown themselves to be suited to correct laying operations in the case of use with small diameter rolling products at high speed because they are not able to force the rolled product to follow its theoretical trajectory.

A solution, addressed at reducing in greater measure, wear of the rod and the pipe caused by their mutual friction, has been proposed in the patent application EP-A-832701 in which, inside the pipe, a series of cylindrical shaped elements with an axial hole are inserted; such elements are made of materials with appropriate hardness and are placed, as elements in a collar, in a manner such that the internal holes form a substantially continuous canal in which the metallic rod to be wound runs. The canal, due to the thickness of the rings, has in such a manner, reduced size with respect to that of the internal diameter of the laying pipe and thus allows working with rods of thinner dimensions, offering the rod an improved guide than that offered by the canal of the laying pipe in the absence of such rings, the free internal space in such case being too large. The document furthermore presents a centrifugation for which the holes of the rings are realised in a manner so as to not create protuberances or discontinuities that can damage the metallic rod during the delivery. Furthermore, it discloses a method allowing for quick replacement of the ring elements, at the moment in which their wear has reached a predetermined level. Such a solution offers greater wear management since there is no need to replace the entire pipe, but only those parts with worn rings.

Such a solution presents some disadvantages, amongst which the fact that the use of the rotor which sustains the laying pipe is usable only for a limited range of rolling products, that is those whose diameter varies in the interval of 5 to 7,5 mm. In fact, typically, the nominal diameter of the canal formed by the rings is 12 mm and, in cases in which it is necessary to produce rolling products with greater diameters it is necessary to replace the entire rotor with one which supports a conventional laying pipe, without rings in its interior. In fact, it is not possible to keep the same rotor and replace the pipe fitted with rings with one which is without because in such a case the masses involved are so different that this would cause significant balancing problems because of the high rotational speeds of the rotor.

In the past, with the aim to reducing the problems resulting from wear, a solution using a laying pipe with high thickness walls, with an external diameter of about 50 mm which corresponded to an internal diameter of 20 mm has been proposed, but such a solution was not ideal because it was however necessary to replace the rotors in the case of the winding of rolling products of diameter greater than 14-16 mm. A further disadvantage of such a solution was the technical difficulty which involved the shaping and the bending of a pipe with walls of large thickness.

### SUMMARY OF THE INVENTION

A primary object of the present invention is that of overcoming the above drawbacks, by providing a laying pipe which improves the operating stability of the winding of rolling products small diameter.

Another object of the invention is that of obtaining a laying pipe which can be used for products with a wide range of diameters, which is versatile and cost effective in operation.

These objects, and others which will be evident in view of the following description, are reached, according to claim 1, by a laying pipe for rolled products comprising a first external pipe consisting of a first substantially rectilinear section, a second substantially spiral-shaped section and by a third, substantially circular section characterised by the fact of providing a second pipe inserted inside said first pipe, with an external diameter substantially equal to the internal diameter of said first pipe and with a length at least equal to the length of said first section.

Preferred embodiments of the device according to the invention are defined in the dependent claims.

Thanks to the characteristics of the laying pipe for rolled products, the problems relating to administration costs and quality of operation are overcome.

The laying pipe according to the invention can be used with products of a wide range of diameters, from 4 to 16 mm, without requiring replacement of the pipe, while maintaining an optimal guiding capacity of the low diameter rolled products at high speed.

The solution proposed by the present invention also allows to operate with the same rotor, only replacing the laying pipe in case of use on large sized rolling products, having a diameter larger than 16 mm, because the replacement of the pipe with one of a different diameter does not entails the unbalancing of the rotor. As a whole, the rolled product laying system has reduced operating costs with respect to other systems of the known type. It allows the improvement of the winding characteristics of low diameter wire or rod, as the stability characteristics of the system are linked to a good guiding of the rolled product in its initial section. Furthermore, the improved guiding conferred on the rolled in the initial section of the laying pipe determines better conformation of the heads and tails of the rolls. The reduction in the initial angle of impact of the rolled product on the laying pipe, as a consequence of the reduction of the internal diameter, results in the advantage of further reducing the wear in the initial zone thus extending the working lives of the pipes.

### BRIEF DESCRIPTION OF THE FIGURES

Further characteristics and advantages of the invention will become apparent in the light of a detailed description of a preferred, but not exclusive embodiment of a laying pipe for rolling products illustrated by way of non limiting exemple with help of the appended drawings in which:

FIG. 1 represents a side view of the laying pipe for rolling products according to the invention;

FIG. 2 represents a elevation view of the pipe in FIG. 1;

FIG. 3 represents a enlarged view of a particular of the pipe in FIG. 1.

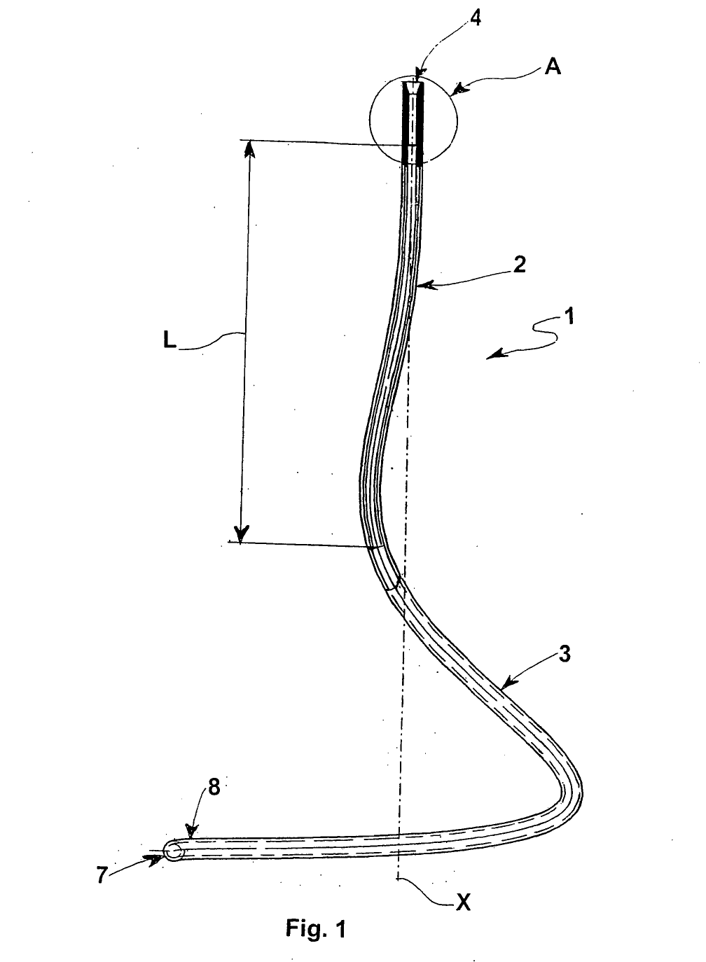

### DETAILED DESCRIPTION OF A PREFERRED EMBODIMENT

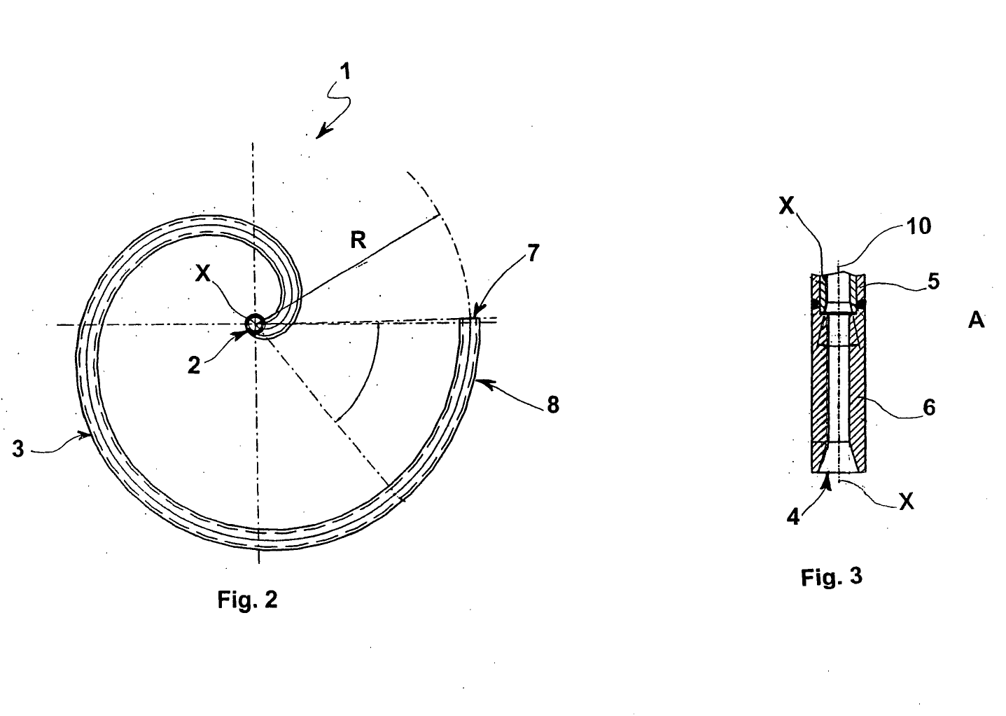

With particular reference to the cited Figures, a laying pipe globally referred to by reference numeral 1 has a spatial shape substantially made up of a first section 2 of almost rectilinear conformation, and by a second section 3 with a conformation approximating that of a spiral. Section 2 of the pipe, almost rectilinear, has an axis X which at the end 4, which is the entry end for the rolled product during the laying operation, coincides with the axis of rotation of the rotor, of conventional type and not illustrated in the Figure. In the description, we will make reference indifferently to wires, rods or thin bars to indicate the products which can be wound using the laying rotor, intending with this that the laying pipe of the invention can be used with rolling products of a similar shape. In the successive portion of section 2 of the pipe, as is more easily visualised in FIG. 2, the axis X of the pipe deviates slightly from the axis of rotation of the rotor and successively, with a sufficiently joined section of the pipe, with a wide radius of curvature, passes to the second section of the laying pipe 3 which terminates with the end 7 from which the rolled product exits to make up the coil or roll.

The two sections 2 and 3 of the pipe, in side view, are almost equal in length. A second pipe 10 is provided, which is located inside the first external pipe 5. Pipe 10 forms an interior coating for pipe 5 and is placed along the almost rectilinear section 2, whilst the substantially spiral section 3 remains formed only by the external pipe 5.

The internal pipe 10 is inserted into the external pipe 5 prior to the realisation by shaping and folding of pipe 5. Preferably the two pipes 5 and 10 are welded together in the end section near to the entry end 4 of the rolled product.

The external pipe 5 has a sectional dimension very close to that of the conventional, simple type pipes, lacking internal rings, and used singularly. The external diameter of pipe 5 is of about 50 mm, and the internal diameter is of about 34 mm.

The internal pipe 10 has external an diameter substantially equal to the internal diameter of the external pipe 5, and internal diameter of around 20 mm. The invention can be realised with pipes of different dimensions still in relation to the rolled product on which the laying operation must be performed.

The internal pipe 10 has a length L slightly greater than the first rectilinear section 2 of the laying pipe 1. Advantageously, it ends slightly downstream from the point where the first bend which joins the rectilinear section to the spiral section 3 is located, so that the rounded rod which is subjected to coiling does not scrape against the internal walls of the external pipe 5 corresponding with said curve.

Preferably the internal pipe 10 and external pipe 5 are bent jointly to their predefined shape by means of a unique forming operation.

In a preferred, and particularly advantageous embodiment, the substantially rectilinear section 2 has a length of less than 1,5 m. In another advantageous variant of the laying pipe 1, the spiral section 3 has for an end section 8, a substantially circular shape. This third section 8 is of a length such as to define a centre angle of around 50°.

As the pipe 10 is inserted only into the initial section of the external pipe 5, in which the bending radius of the rod has not reached its maximum, it is possible to roll products with a maximum diameter up to 16 mm without the danger of jamming of the product inside the pipe. Optimal use of the laying pipe is therefore that with products of broader use having a diameter comprised of between 5 and 16 mm. Within this product range one can use the same laying pipe 1, with optimal coiling results and without the need to make any replacement of the laying pipe 1.

In particular cases the internal diameter of the initial pipe can be reduced to 16 mm, thus limiting the use of the laying pipe to rolled products with a range of diameters from 5-12 mm.

The construction according to the invention of the laying pipe 1, which guarantees dynamic behaviour similar to that of conventional type pipes, without introducing imbalances with respect to the latter, allows therefore the performance of the coiling operation with the same rotor head also with rolling products, such as rounded bars, of diameter greater than 16 mm. In use with products of diameter up to 16 mm, a pipe 1 according to the invention as described above is used, whilst in the case in which the coiling operation of products having diameter greater than 16 mm must be performed, the laying pipe 1 of the invention can be substituted by a conventional type pipe, of external diameter of around 50 mm and of internal diameter of around 34 mm. The dynamic behaviour remains substantially similar and balancing of the rotor is not required, since the internal pipe 10 is placed only in the initial section of pipe 1 which is close to the axis of rotation of the rotor, and its replacement with another laying pipe without second internal pipe does not imply substantial unbalancing of the rotor itself.

In an advantageous variant of the invention the initial section of the pipe 1 has a sleeve 6, welded to the end of the internal 10 and external 5 pipes. This sleeve, made of material of appropriate hardness, has the edges of the entry holes appropriately shaped so as to avoid the danger of damaging the rolled product entering the pipe because of friction or of any interference with the edges of said entry hole. This is done by means of a fillet or a chamfered edge

1. A laying pipe (1) for rolled products comprising a first external pipe (5) having a first substantially rectilinear section (2), a second substantially spiral shaped section (3) and a third substantially circular section (8) characterised in that it comprises a second pipe (10) inserted inside said first pipe (5), having an external diameter substantially equal to the internal diameter of said first pipe (5) and a length at least equal to the length of said first section (2) of the first external pipe (5).

2. The pipe according to claim 1, wherein said second pipe (10) has a length little longer than said first section (2).

3. The pipe according to claim 2, wherein said first section (2) comprises the first bending connection to said second section (3).

4. The pipe according to claim 2, wherein said first (5) and second (10) pipes are fixed to each other by welding at the rolled products entry end (4).

5. The pipe according to claim 3, wherein said internal pipe (10) is a continuous single piece.

6. The pipe according to claim 4, wherein said laying pipe (1) has a sleeve (6) fixed at the rolling product entry end (4), the sleeve having a fillet or chamfered edge.

7. The pipe according to claim 1, wherein the length of said first section (2) is shorter than 1,5 m.

8. The pipe according to claim 1, wherein said third section (8) has the length of a circumference with central angle smaller than 100°.
